(19) United States
(12) Patent Application Publication
(10) Pub. No.: US 2018/0022660 A1
(43) Pub. Date: Jan. 25, 2018

(54) ARBUSCULAR MYCORRHIZAL WETTABLE POWDER COMPOSITIONS AND METHODS OF THEIR USE

(71) Applicant: Valent BioSciences LLC, Libertyville, IL (US)

(72) Inventors: Bala N. Devisetty, Buffalo Grove, IL (US); Alok Adholeya, St Louis, MO (US)

(21) Appl. No.: 15/656,319

(22) Filed: Jul. 21, 2017

Related U.S. Application Data
(60) Provisional application No. 62/365,693, filed on Jul. 22, 2016.

(51) Int. Cl. C05F 11/08; C05G 3/00

(52) U.S. Cl. CPC C05F 11/08; C05G 3/0005

(57) ABSTRACT

The present invention is directed to Mycorrhizal wettable powder formulations containing lactose and sodium lignosulfonate. The present invention is further directed to methods of improving plant growth by applying a Mycorrhizae wettable powder formulation containing lactose and sodium lignosulfonate to a plant or an area where a plant will grow including plant root zones and furrows.

### FIELD OF THE INVENTION

The present invention relates to Mycorrhizal wettable powder formulations containing lactose and sodium lignosulfonate. The present invention further relates to methods of improving plant growth by applying a Mycorrhizae wettable powder formulation containing lactose and sodium lignosulfonate to a plant or an area where a plant will grow including plant root zones and furrows.

### BACKGROUND OF THE INVENTION

Huge amounts of water and fertilizer are utilized across agricultural and landscaping practices. These practices, although readily accepted and necessary, lead to an exacerbation of water quantity and quality issues across the world. For example, agriculture uses about 70% of the accessible freshwater. The water that is not used may be contaminated by dangerous chemicals found in fertilizers. Specifically, contamination of municipal water supplies by nitrates is dangerous to human health and increased phosphate content in rivers and streams leads to lower oxygen levels and possibly large-scale fish death.

Mycorrhizae are symbiotic associations between fungi (i.e. mycorrhizal fungi) and the roots of plants. Mycorrhizal fungi are associated with greater than 90% of all land plants including crops, grasses and trees. Mycorrhizal fungi provide many important benefits to plants including enhanced absorption of water and nutrients from the soil, increased drought resistance, increased pathogen resistance and protection, enhanced plant health and vigor, minimized effects of external stress, and enhanced seedling growth. In turn, the external application of Mycorrhizal fungi to plants can lead to less irrigation and fertilization, which saves water and reduces the amount of chemicals, such as nitrates and phosphorus, and almost all the micronutrients. Mycorrhizal fungi are most effective when introduced to the soil prior to seed germination or at early stages of plant root proliferation.

Current Mycorrhizae formulations include those developed by Mycorrhizal Applications, which produces liquid suspensions and wettable powders as seed treatments and in-furrow formulations. However, these formulations only contain about 7,600 propagules (“ppg's”) per gram for seed treatments, about 950 ppg's per gram for in-furrow formulations and about 280 ppg's per gram for wettable powders and have been known to clog spray nozzle screens as large as 50 mesh. Further, current Mycorrhizae formulations are not “application friendly” and lack physical stability and homogeneity. Particularly, in wettable powders, the use of clay as a carrier leads to rapid settling and increased heterogeneity.

Accordingly, there is a need to develop new Mycorrhizae formulations capable of delivering a higher concentration of Mycorrhizal fungi while maintaining a prolonged and efficient viability and non-dormant propagules, as well as improved physical stability and homogeneity.

### SUMMARY OF THE INVENTION

The present invention is directed to wettable powder compositions containing Mycorrhizae, lactose and sodium lignosulfonate.

The present invention is further directed to methods of improving plant growth by applying the compositions of the present invention to a plant or an area where a plant will grow including plant root zones and furrows.

### DETAILED DESCRIPTION OF THE INVENTION

As used herein, the terms “Mycorrhiza” or “Mycorrhizae” refers to an organic material containing a Mycorrhizal fungus and the plant roots to which the Mycorrhizal fungus is symbiotically associated. The symbiotic association of the Mycorrhizal fungus to the plant roots may be either intracellular (i.e. arbuscular Mycorrhiza) or extracellular (i.e. ectomycorrhiza). Other types of Mycorrhiza, such as ericoid, arbutoid, monotropoid and Orchid Mycorrhiza, are also encompassed within the term “Mycorrhiza” or “Mycorrhizae.”

As used herein, the term “propagules”(ppg's) refers to any mycorrhizal material capable of forming symbiosis with plant roots, such as seeds, seedlings, growing agriculture or tree crops, clonal and micro propagated plants, and the like.

As used herein, the term “plant propagation material” refers to seeds and seedlings of all kinds (fruit, tubers, and grains), clonal and micro propagated plants, and the like.

As used herein, “improving” means that the plant has more of the specific quality than the plant would have had it if it had not been treated by methods of the present invention.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

As used herein % w/w denotes weight by total weight of the composition. All concentrations listed herein are in % w/w unless otherwise described.

The articles “a,” “an” and “the” are intended to include the plural as well as the singular, unless the context clearly indicates otherwise.

The terms “composition” and “formulation” are used interchangeably throughout the application.

As used herein, the term “wettable powder” refers to a dry, finely ground formulation that is capable of forming a suspension when mixed with water or another compatible liquid diluent.

In one embodiment, the present invention is directed to a wettable powder composition comprising from about 0.4% to about 5% w/w Mycorrhizae technical powder concentrate containing from about 300,000 to 400,000 propagules per gram (ppg's/g) and from about 75% to about 98% w/w lactose.

In a preferred embodiment, the compositions of the present invention are free of water.

In another preferred embodiment, the compositions of the present invention contain a free flow aid. In a more preferred embodiment the free flow aid is at a concentration from about 1% to about 5% w/w.

Free flow aids suitable for use in the present invention include, but are not limited to, Zeofree® 80 (Zeofree is a registered trademark of J.M. Huber Corporation). Zeofree® 80 is a silicon dioxide powder and has the CAS no. 112926-00-8.

In another preferred embodiment, the compositions of the present invention contain a dispersant. In a more preferred embodiment the dispersant is at a concentration from about 1% to about 15% w/w.

Dispersants suitable for use in the present invention include, but are not limited to, sodium salt of methyl vinyl ether/maleic acid half-ester copolymer, optionally with polyvinylpyrrolidone, a lignosulfonate or metal salt thereof such as Ultrazine NA; a sulfonated naphthalene/formaldehyde condensate; a high molecular weight block copolymer with pigment affinic group; polyacrylates; ammonium polycarboxylates; sodium salt of polycarboxic acid; 1,4 bis(2-ethylhexyl)sodiumsulfosuccinate; polyether-polycarbonate sodium salt; maleic acid-olefin co-polymer; ammonium polyacrylate; C6-C15 secondary alcohol and alkyl aryl sulfonate and alkyl naphthalene sulfonate. Ultrazine NA is also known as sodium lignosulfonate and is available from Borregaard Lignotech. In a preferred embodiment the dispersant is sodium lignosulfonate.

In another embodiment, the compositions of the present invention may contain further or additional excipients such as wetting agents, preservatives, stabilizers, binders, film-formers, anti-foaming agents, additional free-flow agents such as sodium aluminosilicates, spreaders, stickers, spreader-stickers, pH regulators, dyes, ultra-violet light protectants, a vehicle or other components which facilitate production, storage stability, product handling application and biological efficacy. In a preferred embodiment, the compositions of the present invention comprise more than about 1,100 propagules per gram.

In another preferred embodiment, Mycorrhizae propagules of the present invention are capable of passing through a sieve that contains openings from about 105 to about 150 micrometers in diameter.

In a more preferred embodiment, the present invention is directed to a wettable powder composition comprising:
from about 1% to about 5% w/w Mycorrhizae technical powder concentrate;
from about 80% to about 97% w/w lactose;
from about 1% to about 15% w/w sodium lignosulfonate; and
from about 1% to about 5% w/w silicon dioxide.

In a most preferred embodiment, the present invention is directed to a wettable powder composition comprising:
about 0.4% w/w Mycorrhizae powder concentrate;
about 90.6% w/w lactose;
about 5% w/w sodium lignosulfonate; and
about 4% w/w silicon dioxide.

In another embodiment, the compositions of the present invention may be uniformly blended in a diluent.

Diluents suitable for use in the present invention include but are not limited to sugars, maltodextrins, humic acid, seaweed extracts, alginates, celluloses, seed flowers such as cotton seed, corn seed, beans, sunflower seed, among others.

Compositions of the present invention may be applied to any plant or plant propagation material thereof that may benefit from improved growth including agricultural crops, annual grasses, trees, shrubs, ornamental flowers and the like. Compositions of the present invention may further be applied to any area where a plant will grow including soil, a plant root zone and a seed furrow.

In another embodiment, the present invention is directed to methods of improving plant growth comprising applying a composition of the present invention to an area where a plant will grow, preferably soil and more preferably a furrow or a plant root zone.

The compositions of the present invention may be applied at a rate of from about 5 to about 400 grams of Mycorrhizae formulation per hectare, preferably from about 10 to about 300 grams per hectare and more preferably from about 25 to about 300 grams per hectare.

The compositions of the present invention may be combined with or applied concomitantly or sequentially with other seed treatment formulations containing chemical and/or biological or biorational pesticides, plant growth regulators, biostimulants and/or fertilizers.

These representative embodiments are in no way limiting and are described solely to illustrate some aspects of the invention.

Further, the following example is offered by way of illustration only and not by way of limitation.

### EXAMPLE

### Example 1. Formulation of a Mycorrhizal Wettable Powder

TABLE 1

| | % w/w |
|---|---|
| Mycorrhizae | 0.4 |
| Lactose | 90.6 |
| Ultrazine NA | 5 |
| Zeofree ® 80 | 4 |

Initially, root fragments containing Mycorrhizae propagules are reduced to a desirable size range by appropriate size reduction methods ensuring spore and propagule integrity. The processed Mycorrhizae technical powder concentrate is capable of passing through a standard sieve #100 (i.e. 149 micrometers) and/or through a standard #140 (105 micrometers) sieve. A free-flow agent such as silicon dioxide available under brand names such as Zeofree® 80 (Zeofree® 80 is a registered trade mark of J.M. Huber Corporation) may be used in aid in propagule size reduction and further handling. Zeofree® 80 has the CAS #: 112926-00-8.

Initially, a pre-blend of Mycorrhizae technical powder concentrate is prepared in ½ the required quantity of Zeofree® 80 and added to a portion of Lactose in the powder mixing blender. To this, the remaining portion of Zeofree® 80 and the required quantity of lignosulfonate is added. The remaining portion of Lactose is added and blended until a homogenous product is obtained.

### Example 2. Physical Properties of Mycorrhizae Wettable Powder Compositions

TABLE 2

| | | MycoApply |
|---|---|---|
| | Example 1 | Ultrafine Endo |
| Carrier | Lactose | Clay |
| | (Water soluble) | (Water insoluble) |
| Mycorrhizae Concentration | 0.43 | — |
| (% w/w) | | |
| Mycorrhizae Concentration | 1,120 | 280 |
| (ppg/g) | | |
| Density | 0.81 | 0.67 |
| (g/mL) | | |
| pH (at 10% suspension) | 7.2 | 5.9 |
| % Suspension in 30 minutes | 98.5% | 7.0% |

As shown in Table 2, the compositions of the present invention have a greater density than prior art Mycorrhizae compositions. Further, the compositions of the present invention have a more neutral pH and contain four times the standard 280 ppg/g concentration of Mycorrhizae wettable powders. Finally, the wettable powder compositions of the present invention are water soluble compared to clay which is water in-soluble.

### Example 3. Bio-efficacy of Mycorrhizae Wettable Powder Compositions

Prior art formulations and compositions of the present invention were diluted to standard tank-mix Mycorrhizae application concentrations in water for in-furrow application and applied in-furrow in the green house. Mycorrhizae colonization was determined at harvest and is presented in Table 5 as a percent root length colonization by Arbuscular Mycorrhizae in corn.

TABLE 3

| | Unformulated | | |
|---|---|---|---|
| | Mycorrhizae | MycoApply | |
| Formulation | Concentrate | EndoMaxx | Example 1 |
| Concentration | 313,845 | 22,500 | 1,120 |
| (ppg/g) | | | |
| % Colonization | 8.95% | 10.94% | 11.42% |

As shown in Table 3, 11.42% of corn grown in-furrows treated with the composition of Example 1 were colonized with Mycorrhizae. This result is comparable to that of commercial MycoApply EndoMaxx (10.94%) and was higher than unformulated Mycorrhizae concentrate (8.95%). Further, compositions of the present invention showed similar or better uptake of nutrients including nitrogen, phosphorous, potassium, zinc, iron, boron and molybdenum in plant shoots as compared to MycoApply EndoMaxx.

### Example 4. Spore Viability of Mycorrhizae Wettable Powder Compositions

Unformulated Mycorrhizae compositions and compositions of the present invention were stored at variable ambient temperature, and constant 5° C., 25° C. and 30° C. for 12 months. Mycorrhizae spore viability was measured as a percent of total spores and is presented below in Table 4.

TABLE 4

| Formulation | 0 Months | 12 Months |
|---|---|---|
| Unformulated Mycorrhizae | 46% | 38% |
| Concentrate | | |
| Example 1 | 40% | 56% |

As seen in Table 4 wettable powder compositions of the present invention maintained spore viability over 1 year under variable ambient storage conditions and at constant storage temperatures of 5° C., 25° C., and 30° C.

What is claimed is:

1. A wettable powder composition comprising from about 0.4% to about 5% w/w Mycorrhizae technical powder concentrate from about 75% to about 98% w/w lactose, and from about 1% to about 15% w/w of a dispersant, wherein % w/w denotes percent weight by total weight of the composition.

2. The composition of claim 1, wherein the dispersant is sodium lignosulfonate.

3. The composition of claim 1, further comprising a free flow aid at a concentration from about 1% to about 5% w/w.

4. The composition of claim 3, wherein the free flow aid is silicon dioxide.

5. The composition of claim 1, wherein the composition comprises more than about 1,000 propagules per gram.

6. The composition of claim 1, wherein the composition passes through a sieve comprising openings from about 105 to about 150 microns in diameter.

7. A wettable powder composition comprising:
from about 0.4% to about 5% w/w Mycorrhizae technical powder concentrate
from about 78% to about 97% w/w lactose;
from about 1% to about 15% w/w sodium lignosulfonate; and
from about 1% to about 5% silicon dioxide,
wherein % w/w denotes percent weight by total weight of the composition.

8. A wettable powder composition comprising:
about 0.4% w/w Mycorrhizae technical powder concentrate
about 90.6% w/w lactose;
about 5% w/w sodium lignosulfonate; and
about 4% w/w silicon dioxide,
wherein % w/w denotes percent weight by total weight of the composition.

9. A method of improving plant growth comprising applying a composition of claim 8 to an area where a plant will grow.

10. The method of claim 9, wherein the area where a plant will grow is soil.

11. The method of claim 10, wherein the soil in the form of a furrow.

12. The method of claim 9, wherein the area where a plant will grow is a plant root zone.
